(19) United States
(12) Patent Application Publication
(10) Pub. No.: US 2026/0043601 A1
(43) Pub. Date: Feb. 12, 2026

(54) REFRIGERATION APPLIANCE

(71) Applicant: BSH Hausgeräte GmbH, München (DE)

(72) Inventors: Tianming YU, Chuzhou (CN); Chenyang GAN, Nanjing (CN); Yongqin ZHAO, Nanjing (CN); Junxin LIU, Nanjing (CN); Qidong LI, Nanjing (CN)

(21) Appl. No.: 19/287,067

(22) Filed: Jul. 31, 2025

(30) Foreign Application Priority Data
Aug. 6, 2024 (CN) 202411074128.2
Aug. 6, 2024 (CN) 202411074139.0
Aug. 6, 2024 (CN) 202421892781.5

(51) Int. Cl. F25D 23/02; E05D 11/00

(52) U.S. Cl. CPC F25D 23/028; E05D 11/0054; E05Y 2900/31; F25D 2323/024

(57) ABSTRACT

A refrigeration appliance includes a main body provided with a compartment, a door located in front of the main body, and a hinge connecting the main body and the door, so that the door can rotate relative to the main body. The hinge includes a hinge plate, one end of the hinge plate is fixed to the main body, and the other end of the hinge plate is located at the upper part of the door. A line having a first part arranged on the main body and a second part arranged on the door. A guide member is configured to guide the line, where the guide member is adapted to rotate non-coaxially with the door as the door is being opened or closed. The guide member includes a first end that is pivotally connected and a second end opposite to the first end.

### CROSS-REFERENCE TO RELATED APPLICATION

This application claims the priorities, under 35 U.S.C. § 119, of Chinese Patent Applications CN 202421892781.5, filed Aug. 6, 2024; CN 202411074128.2, filed Aug. 6, 2024, and CN 202411074139.0, filed Aug. 6, 2024, the prior applications are herewith incorporated by reference in their entireties

### FIELD AND BACKGROUND OF THE INVENTION

Embodiments of this application relate to a refrigeration appliance.

In some scenarios, a line, such as an electric wire or a pipe for conveying liquid, needs to be directly arranged between a main body and a door of a refrigeration appliance. In a solution in which the door is rotatably connected to the main body, the line is inserted into a hinge hole of a door body in common methods, so that the line can rotate coaxially with the door. An advantage of such an arrangement is that the line does not move relative to the door and the main body during movement of the door.

However, under some limiting conditions, the line cannot rotate coaxially with the door. Consequently, the line may move relative to the door and the main body.

International patent disclosure WO 23046448 A1 discloses a refrigeration appliance, including a line guide mechanism arranged adjacent to a hinge and configured to guide a line from a household appliance main body to a household appliance door unit, and a continuous line guide mechanism connected to the line guide mechanism and arranged on a narrow side of a household appliance door and configured to continue to guide the line from the line guide mechanism to the household appliance door unit. The guide mechanism includes a line guide element that is pivotable during opening and closing of the door, and the line extends inside the line guide element to be guided to the door.

European patent application EP 2743435 A1 discloses a refrigeration appliance, including a cabinet, at least one door, and at least one flexible tubular element. The flexible tubular element is inserted into one side of the cabinet and the other side of the door. The door is connected to the cabinet via at least one hinge, to allow the door to rotate about a rotation axis for opening and closing. The refrigeration appliance further includes a guide element. The guide element includes a guide pivot defining a guide axis. The flexible element is adapted to at least partially wind and unwind about the guide axis. A support member defines a surface that is substantially perpendicular to the guide axis and is adapted to support the flexible tubular element.

### SUMMARY OF THE INVENTION

A problem to be solved in embodiments of this application is how to provide an improved refrigeration appliance.

Another problem to be solved in embodiments of this application is how to provide a refrigeration appliance having an improved line guide mechanism.

Problems to be resolved in embodiments of this application are not limited to the foregoing problems, and a person skilled in the art may clearly understand other problems that are not mentioned from the following descriptions.

One aspect of embodiments of this application relates to a refrigeration appliance. The refrigeration appliance includes: a main body provided with a compartment, a door located in front of the main body, and a hinge connecting the main body and the door, so that the door can rotate relative to the main body. The hinge includes a hinge plate, one end of the hinge plate is fixed to the main body, and the other end of the hinge plate is located at the upper part of the door. A line is provided where a part of the line is arranged on the main body, and a part of the line is arranged on the door. A guide member is configured to guide the line, where the guide member is adapted to rotate non-coaxially with the door as the door is being opened or closed, and the guide member includes a first end that is pivotally connected and a second end opposite to the first end. In the vertical direction, the first end is located between the hinge plate and a connection plate located above the hinge plate, and is pivotally connected to the hinge plate and the connection plate.

In a possible embodiment, the refrigeration appliance includes a hinge cover configured to cover the hinge plate from above, where the connection plate is a part of the hinge cover.

In a possible embodiment, the connection plate is located at the front end of the hinge cover and is located above the door when the door is closed.

In a possible embodiment, the refrigeration appliance includes a front guide member, where the front guide member is fixed to the main body, the line extends toward the guide member along the front guide member, and the front guide member includes the connection plate.

In a possible embodiment, the front guide member includes a base plate extending horizontally, the line is lapped on the base plate, and the connection plate includes a tab extending upward from the base plate and bent before extending forward horizontally, to form, between the base plate and the tab, a space for accommodating the first end of the guide member.

In a possible embodiment, the base plate is arranged above the main body and covers the hinge plate; and/or the front guide member is snap-connected to the hinge plate.

In a possible embodiment, the refrigeration appliance includes a hinge cover configured to cover the hinge plate from above, where the upper surface of a tab is in contact with the lower surface of the hinge cover; and/or the hinge cover is snap-connected to the front guide member.

In a possible embodiment, the hinge plate has a first shaft hole, a second shaft hole is provided at the upper part of the first end, a first shaft part for insertion into the first shaft hole is provided at the lower part of the first end, the connection plate has a second shaft part for insertion into the second shaft hole, and the first shaft hole and the second shaft hole are coaxial.

In a possible embodiment, a first raised part protruding toward the connection plate is provided at the upper side of the first end, and the first raised part is in contact with the connection plate; and/or a second raised part protruding toward the hinge plate is provided at the lower side of the first end, and the second raised part is in contact with the hinge plate.

In a possible embodiment, the door is provided with a continuous guide channel extending along the width direction of the door, and the second end of the guide member is located in the continuous guide channel and is movable relative to the continuous guide channel.

In a possible embodiment, a recess is formed at the upper end of the door to accommodate the hinge plate and the guide member, the upper surface of the hinge plate is higher than the bottom wall of the recess. The first end and the second end of the guide member are at different heights and are not on a same horizontal plane, and the guide member has an arc part located between the first end and the second end to provide transition for a height difference between the first end and the second end.

In a possible embodiment, the line is fixed to the guide member and includes a first line section on one side of a fixed part of the line and a second line section on the other side of the fixed part of the line, and during movement of the door, the length of the first line section and the length of the second line section both remain constant.

In a possible embodiment, the line is fixed at or near the second end; and/or the second end is located above the door; and/or the refrigeration appliance includes a cable tie for fixing the line to the guide member, and the line is fixed onto the guide member by the cable tie; and/or a component for fixing the line to the guide member is at least partially located in a guide passage of the guide member.

In a possible embodiment, the refrigeration appliance includes line restriction mechanisms, where the line restriction mechanism is configured to restrict the movement of the line in the length direction of the line to limit the length of the line entering the guide member.

In a possible embodiment, the restriction mechanism is located outside the guide member; and/or the restriction mechanism is located on the main body.

In a possible embodiment, the restriction mechanism includes a stop part and a stop protrusion protruding from the outer side of a first line section, and the stop part defines a stop passage that allows the first line section to pass through and prevents the stop protrusion from passing through.

According to one aspect of embodiments of this application, one end of the guide member may be securely and pivotally connected between the hinge plate and the connection plate.

According to another aspect of embodiments of this application, the guide member is supported by using the hinge plate and the hinge cover, so that the guide member can be stably arranged near the hinge with lower costs.

According to another aspect of embodiments of this application, the length of the first line section and the length of the second line section may remain unchanged as the guide member moves relative to the door. Keeping the line lengths on two sides of a fixed part of a line unchanged helps prevent the line located on one side of the fixed part from being pulled or pushed to the other side of the fixed part, and vice versa, thereby avoiding disorderly movement of the line on a household appliance and damage to the line. Therefore, according to embodiments of the application, the household appliance line can move with the door in a more orderly manner. This is beneficial to improving the safety and reliability of the household appliance.

According to still another aspect of embodiments of this application, a certain amount of movement of the line is allowed, and the line can be prevented from excessive entry into a guide unit, thereby avoiding disordered crowding and damage of the line within the guide unit. This is beneficial to improving the safety and reliability of the household appliance.

The construction of embodiments of this application and other inventive objectives and beneficial effects thereof are clearer and more understandable through description of preferred embodiments with reference to the accompanying drawings.

Additionally or alternatively to the above, a household appliance may additionally or alternatively contain: a main body having a compartment, a door located in front of the main body, a hinge connecting the main body and the door so that the door rotatably moves relative to the main body, and a pipeline, part of the pipeline being located on the main body and part of the pipeline being located on the door. A guiding mechanism is provided and configured to guide the pipeline, the pipeline extending between the main body and the door along the guiding mechanism. The pipeline is adapted to be pushed or pulled within the guiding mechanism to move relative to the guiding mechanism during the movement of the door. A pipeline limiting mechanism is provided and configured to restrict the movement of the pipeline along the length direction of the pipeline and limit the maximum compensation length of the pipeline relative to the guiding mechanism. Preferred embodiments are discussed below.

Additionally or alternatively to the above, the limiting mechanism may comprise a stop portion and a stop protrusion protruding from the outer side of the pipeline, and the stop portion defines a stop channel that allows the pipeline to pass through but prevents the stop protrusion from passing through. Optionally, a hinge cover is configured to cover the hinge from above, and the pipeline limiting mechanism comprises a stop portion located on the hinge cover and is configured to stop the pipeline from continuing moving towards the door. Further optionally, the guiding mechanism comprises a front guiding member fixed to the main body, the pipeline extends towards the door on the main body along the front guiding member, and the pipeline limiting mechanism comprises a stop portion located on the front guiding member and configured to stop the pipeline from continuing moving towards the door. Additionally or alternatively to the above, the pipeline limiting mechanism may be configured to be a component fixing the pipeline to a neighboring pipeline to divide the pipeline into a first pipeline segment located on one side of a fixed part of the pipeline and a second pipeline segment located on the other side of the fixed part, and the length of the first pipeline segment and the length of the second pipeline segment remain constant when the pipeline moves relative to the door and the main body. Additionally or alternatively to the above, the pipeline limiting mechanism comprises a first limiting mechanism configured to limit the range of movement of the part of the pipeline located on the main body towards the door and/or a second limiting mechanism configured to limit the range of movement of the part of the pipeline located on the door towards the main body. Additionally to the above, at least one of the first limiting mechanism and the second limiting mechanism may be configured to be only adapted to limit the movement of the pipeline in one direction along the length direction of the pipeline; and/or the first limiting mechanism is located on the main body, and the second limiting mechanism is located on the door; and/or the first limiting mechanism is located on one end of the guiding mechanism, and the second limiting mechanism is located on the other end of the guiding mechanism. Additionally or alternatively to the above, the guiding mechanism may comprise a rotatable guiding member, at least one end of the guiding member is pivotally connected so that the guiding member is rotatable when the door moves, the pipeline enters from one end of the guiding member and extends out from the other end and extends along the length direction of the guiding member, and the pipeline limiting mechanism limits the maximum compensation length and limits the maximum pipeline length within the guiding member. Additionally to the above, the guiding member may comprise a first end and a second end opposite to the first end. The first end is closer to the main body than the second end, and the pipeline limiting mechanism comprises a first limiting mechanism located upstream of the first end and configured to limit the length of the pipeline entering the guiding member through the first end. The pipeline limiting mechanism contains a second limiting mechanism located downstream of the first end and configured to limit the length of the pipeline entering the guiding member from the second end. The guiding member is in the shape of a hollow bar and has a guide channel extending along the length direction of the guiding member. The guiding mechanism comprises a front guiding member fixed to the main body, and the pipeline extends from the front guiding member to the first end. Additionally to the above, the first end is pivotally connected, the second end is rotatable about the first end, and the pipeline and the pivot axis of the first end extend within the guiding member so as to intersect each other. The hinge comprises a hinge plate, and the first end is pivotally connected to the hinge plate. A hinge cover is configured to cover the hinge, and the first end is pivotally connected to the hinge cover. The pipeline is guided towards the guiding member by the front guiding member, and the first end is pivotally connected to the front guiding member. The first limiting mechanism comprises a stop portion at least partially located on the front guiding member and configured to stop the pipeline from continuing moving towards the guiding member. The first limiting mechanism comprises a stop portion located at the lower side of the hinged cover and configured to stop the pipeline from continuing moving towards the guiding member. The door comprises a guiding continuation groove, the pipeline extends within the guiding continuation groove after extending out from the second end, and the second end is adapted to move within the guiding continuation groove. Additionally to the above, at least one of the first limiting mechanism and the second limiting mechanism may comprise a stop portion and a stop protrusion surrounding the pipeline, and the stop portion defines a stop channel that allows the pipeline to pass through but prevents the stop protrusion from passing through. The second limiting mechanism fixes the pipeline to the guiding member to divide the pipeline into a first pipeline segment located on one side of a fixed part of the pipeline and a second pipeline segment located on the other side of the fixed part, and the length of the first pipeline segment and the length of the second pipeline segment remain constant when the pipeline moves relative to the door and the main body. The second limiting mechanism fixes the pipeline to the second end of the guiding member. The guiding member comprises a fixing hole, and the second limiting mechanism comprises a cable tie passing through the fixing hole and tying the pipeline to the guiding member. Additionally or alternatively to the above, the maximum compensation length may be defined by the length of the pipeline between the stop protrusion and the stop portion when the two are farthest apart; and/or the stop projection comprises a cable tie surrounding the pipeline. The stop portion is located at the lower side of the hinge cover configured to cover the hinge from above. The guiding member contains a front guiding member located on the main body, the pipeline extends towards the door along the front guiding member, and the stop portion is located on the front guiding member. The stop portion contains an elastic hook configured to form a stop channel.

Additionally or alternatively to the above, a refrigeration appliance my contains a main body having a compartment, a door located in front of the main body, a hinge connecting the main body and the door so that the door is rotatable relative to the main body, a pipeline, part of the pipeline being arranged on the main body and part of the pipeline being arranged on the door, and a guiding mechanism configured to guide the pipeline. The guiding mechanism having a guiding member with at least one end pivotally connected, and the guiding member rotating as the door is opened or closed. The pipeline is fixed to the guiding member and comprises a first pipeline segment located on one side of a fixed part of the pipeline and a second pipeline segment located on the other side of the fixed part of the pipeline, and during the movement of the door, the length of the first pipeline segment and the length of the second pipeline segment respectively remain constant. Additionally or alternatively to the above, during the movement of the door, the first pipeline segment and the second pipeline segment may both move relative to the door when the door moves. Additionally or alternatively to the above, the pipeline may be fixed to the guiding member on the door. Additionally or alternatively to the above, the refrigerator may comprise a limiting mechanism configured to limit the length of the first pipeline segment entering the guiding member when the door moves. Additionally to the above, the limiting mechanism may be located outside the guiding member and is located between the guiding member and the end of the first pipeline segment opposite to the fixed part; and/or the limiting mechanism is located on the main body. The limiting mechanism comprises a stop portion and a stop protrusion protruding from the outer side of the first pipeline segment, and the stop portion defines a stop channel that allows the first pipeline segment to pass through but prevents the stop protrusion from passing through. Additionally or alternatively to the above, the guiding member may comprise a first end pivotally connected and a second end rotatable around a pivot end, wherein the pipeline is fixed at or near the second end. The second end is located above the door; and/or the first end is pivotally connected to a hinge plate of the hinge and/or a connecting plate located above the hinge plate and/or a hinge cover. Additionally to the above, the refrigerator my comprise a guiding continuation groove located at the upper end of the door and extending along the width direction of the door, the second end of the guiding member being capable of moving in the guiding continuation groove, and when the door moves, the second pipeline segment moving relative to the guiding continuation groove in the guiding continuation groove as the guiding member pushes or pulls. Additionally to the above, the second end of the guiding member may be adapted to swing relative to the guiding continuation groove in the guiding continuation groove and is adapted so that the swing range is limited by the inner wall of the guiding continuation groove. Additionally or alternatively to the above, the second pipeline segment extends along the width direction of the door, and the second pipeline segment is adapted to move along the width direction of the door along with the guiding member when the door moves. Additionally to the above, the second pipeline segment comprises a U-shaped portion, and the U-shaped portion moves relative to the door under the drive of the guiding member when the door moves. Additionally to the above, the door comprises a partition structure located between two legs of the U-shaped portion to partition the second pipeline segment and maintain the U-shaped distribution of the second pipeline segment when the door moves. Additionally or alternatively to the above, the guiding member is a hollow bar structure; and/or the guiding member has a guide channel penetrating both ends to allow the pipeline to pass through; and/or a cable tie configured to fix the pipeline to the guiding member is comprised, and the pipeline is fixed to the guiding member by the cable tie; and/or the component configured to fix the pipeline to the guiding member is at least partially located in the guide channel of the guiding member. Additionally to the above, the guiding member comprises a fixing hole, and the pipeline is fixed on the guiding member by passing through the fixing hole and being tied to the guiding member by the cable tie; and/or the guiding member comprises an extension piece extending from one end thereof, the pipeline is exposed at a portion corresponding to the extension piece, and the pipeline is fixed to the extension piece. Additionally or alternatively to the above, the household appliance may comprise a main body and a door rotatable relative to the main body, wherein the pipeline assembly comprises: a pipeline; and a guiding member, the guiding member having a guide channel, the pipeline passing through the guide channel, and at least one end of the guiding member being configured to be adapted to be pivotally connected to the household appliance. The pipeline is fixed to the guiding member and comprises a first pipeline segment located on one side of a fixed part of the pipeline and a second pipeline segment located on the other side of the fixed part of the pipeline, and the pipeline is fixed in such a way that the length of the first pipeline segment and the length of the second pipeline segment respectively remain constant during the movement of the door.

Other features which are considered as characteristic for the invention are set forth in the appended claims.

Although the invention is illustrated and described herein as embodied in a refrigeration appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

As a part of the specification and to provide further understanding of the application, the following accompanying drawings illustrate specific implementations of the application, and are used to describe the principle of the application together with the specification.

### BRIEF DESCRIPTION OF THE FIGURES

FIG. 1 is a partial, exploded, perspective view of a household appliance according to an embodiment of this application, where doors are closed;

FIG. 2 is a partial, exploded, perspective view of the household appliance according to an embodiment of this application, where a door is opened;

FIG. 3 is a partial, exploded, perspective view of the household appliance from another angle according to an embodiment of this application, where the door is opened;

FIG. 4 is a partial perspective view of the household appliance according to an embodiment of this application, where a door is opened and a hinge cover and a cover at the top of the door are removed;

FIG. 5 is a top view of the household appliance according to an embodiment of this application, where the door is closed and the hinge cover and the cover at the top of the door are removed;

FIG. 6 is an enlarged, perspective view of a part VI shown in FIG. 4;

FIG. 7 is a perspective view of a guide member according to an embodiment of this application;

FIG. 8 is a perspective view of the guide member from another angle according to an embodiment of this application;

FIG. 9 is a perspective view of a front guide member according to an embodiment of this application;

FIG. 10 is a perspective view of the front guide member from another angle according to an embodiment of this application;

FIG. 11 is a perspective view of the hinge cover according to an embodiment of this application;

FIG. 12 is a perspective view of a line assembly according to an embodiment of this application;

FIG. 13 is a partial, exploded, perspective view of the household appliance according to another embodiment of this application; and

FIG. 14 is a perspective view of the hinge cover according to another embodiment of this application.

### DETAILED DESCRIPTION OF THE INVENTION

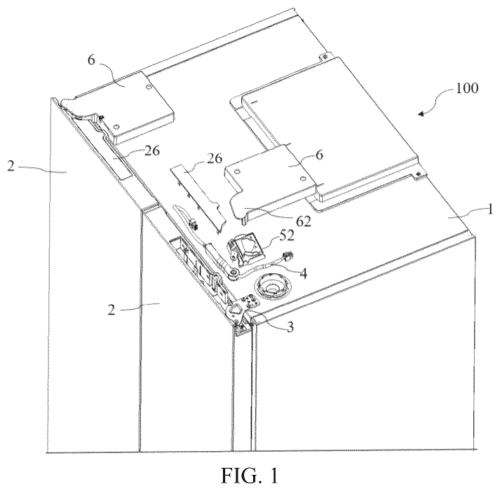

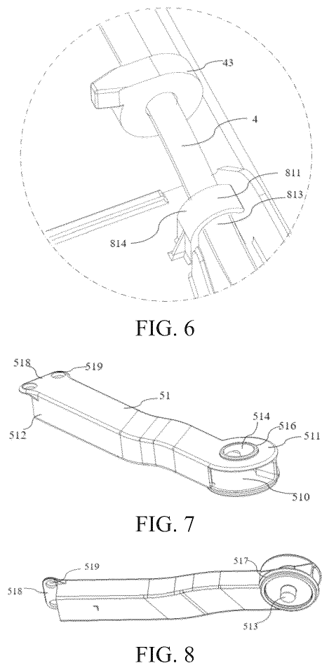

Referring now to the figures of the drawings in detail and first, particularly to FIGS. 1-6 thereof, there is shown a household appliance 100, for example, a refrigeration appliance, includes a main body 1 provided with a storage compartment 10 and at least one door 2 arranged in front of the main body 1. The door 2 is rotatably located in front of the main body 1 through a hinge 3.

One end of the hinge 3 is connected to the main body 1, and the other end of the hinge 3 is connected to the door 2. The hinge 3 may include a hinge plate 31 having one end fixed to the main body 1. The other end of the hinge plate 31 extends to the upper part of the door 2 and is rotatably connected to the door 2.

In an embodiment, the hinge 3 is arranged such that a rotation axis of the door 2 shifts during opening of the door 2.

Particularly, during opening of the door 2, a side of the door 2 connected to the hinge 3 may be displaced inward by a preset amount, to avoid interference between the door 2 and a facility (for example, a cabinet) around the household appliance 100.

The household appliance 100 may include a pair of doors 2 that open in opposite directions, and each door 2 is connected to the main body 1 through a corresponding hinge 3. In FIG. 1, a hinge disposed on one side of the household appliance 100 is covered by a hinge cover 6 from above, and a hinge 3 disposed on the other side of the household appliance 100 is exposed because the hinge cover 6 is removed.

The household appliance 100 includes a line 4. The line 4 may be an electric wire or a wire harness for transmitting electricity, or may be a water pipe for transferring liquid such as water. A part of the line 4 is located at the main body 1, and a part of the line 4 is located at the door 2, so that the line 4 extends between the main body 1 and the door 2. The line 4 is usually a flexible line element.

Two ends of the line 4 may each provided with a connector 45 to mate with matching connectors on the main body 1 and the door 2, respectively. It should be understood that in another embodiment, when necessary, the line 4 may further include one or more connectors located between the two connectors 45.

The line 4 extends across the main body 1 and the door 2 along a guide mechanism 5. The line 4 is restricted and covered by the guide mechanism 5 to some extent, facilitating more stable deployment of the line 4 on the household appliance 100.

The guide mechanism 5 includes at least one guide member 51 that rotates during movement of the door 2. The guide member 51 is strip-shaped and has a guide passage 510 extending along the length direction of the guide member 51. The line 4 extends along the guide passage 510. At least one end of the guide member 51 is pivotally connected, so that the guide member 51 can rotate during opening or closing of the door 2. In this embodiment, the guide member 51 is an integrally injection-molded, hollow, and long strip-shaped plastic component.

A rotation axis of the guide member 51 extends vertically but is not coaxial with the rotation axis of the door 2. The rotation axis of the guide member 51 intersects with the guide passage 510. Therefore, the line 4 is arranged inside the guide member 51 to intersect with the rotation axis of the guide member 51.

In an exemplary embodiment, a first end 511 of the guide member 51 close to the main body 1 is rotatably connected, and a second end 512 of the guide member 51 close to the door 2 is located above the door 2 and may rotate relative to the first end 511 of the guide member 51.

As shown in FIG. 5, when the door 2 is in a closed state, the guide member 51 is approximately parallel to the front surface of the main body 1. When the door 2 is opened, the second end 512 of the guide member 51 rotates around the first end 511 to be located at a position farther from the hinge 3 than the first end 511.

The guide member 51 is rotatably connected to the hinge plate 31 and is supported on the hinge plate 31. The guide member 51 is connected to a position of the hinge plate 31 extending to the front of the main body 1, so that the rotation axis of the guide member 51 is located in front of the main body 1. In an embodiment, one of the hinge plate 31 and the guide member 51 is provided with a shaft hole, and the other of the hinge plate 31 and the guide member 51 is provided with a rotation shaft inserted into a shaft hole, so that during opening of the door, the guide member 51 rotates relative to the hinge plate 31.

The upper side of the guide member 51 may also be pivotally connected. In an embodiment, the household appliance 100 includes a connection plate 525 located above the hinge plate 31, and the first end 511 of the guide member 51 is located between the connection plate 525 and the hinge plate 31 in the vertical direction and is separately axially connected to the connection plate 525 and the hinge plate 31.

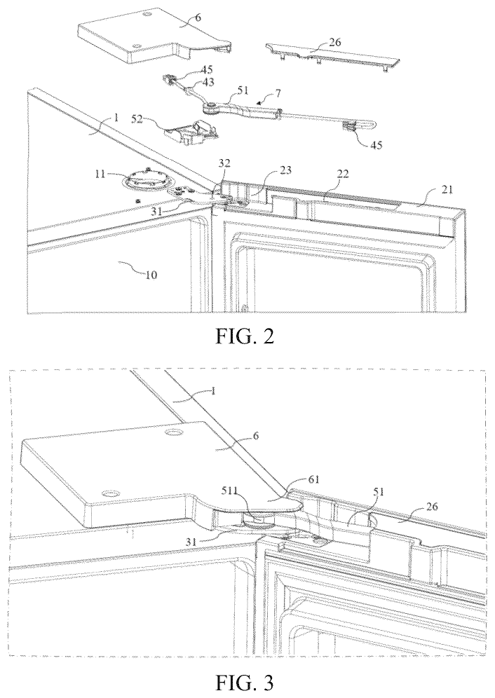

As shown in FIG. 2, FIG. 7, and FIG. 8, the hinge plate 31 has a first shaft hole 32, a first shaft part 513 configured to be inserted into the first shaft hole 32 is provided at the lower side of the guide member 51, and a second shaft hole 514 configured to accommodate a second shaft part 526 extending downward from the connection plate 525 is provided at the upper side of the guide member 51. The first shaft hole 32 and the second shaft hole 514 are coaxial.

Annular raised parts 516 and 517 may be respectively provided on upper and lower sides of the first end 511 of the guide member 51. When the guide member 51 rotates, the circular raised parts 516 and 517 are respectively in friction contact with the connection plate 525 and the hinge plate 31. The annular raised parts 516 and 517 are of thin-walled structures. In this way, friction between the guide member 51, the hinge plate 31, and the connection plate 525 can be reduced. In addition, a group of fine-sized protruding points may also be formed on the upper and lower surfaces of the first end 511 to reduce friction.

A recess 23 is formed at the upper end of the door 2 to accommodate the hinge 3 and the guide member 51. The upper surface of the hinge plate 31 is higher than the bottom wall of the recess 23. The first end 511 and the second end 512 of the guide member 51 are at different heights and are not on a same horizontal plane. In this way, the first end 511 can operates together with the hinge plate 31, and the second end 512 can operates together with the door 2. A height difference between the first end 511 and the second end 512 of the guide member 51 may be bridged via an arc part 515 located in a middle region of the guide member 51.

The door 2 is further provided with a continuous guide channel 22 adjacent to and communicated with the recess 23. The continuous guide channel 22 extends at the top of the door 2 along the width direction of the door 2. The second end 512 of the guide member 51 is located in the continuous guide channel 22.

As the door 2 is being opened or closed, the second end 512 extends completely or partially into the continuous guide channel 22 of the door 2 to guide movement of the line 4 in the door 2.

The continuous guide channel 22 may be formed in an end cover 21 of the door 2. The end cover 21 may be inseparably combined with a heat-insulation material of the door 2 during a foaming process of the door 2. An end of the continuous guide channel 22 connected to the hinge 3 facing the door 2 is set to be open, and an end away from the hinge 3 is set to be closed.

The continuous guide channel 22 is open upward, so that the line 4 can be easily mounted on the door 2. The door 2 includes a cover 26 configured to seal the continuous guide channel 22 from above.

The second end 512 of the guide member 51 extends into the continuous guide channel 22 through the recess 23 and an open end of the continuous guide channel 22, to guide the line 4 to into the continuous guide channel 22. Driven by the guide member 51, the line 4 moves relative to the door 2 in the continuous guide channel 22.

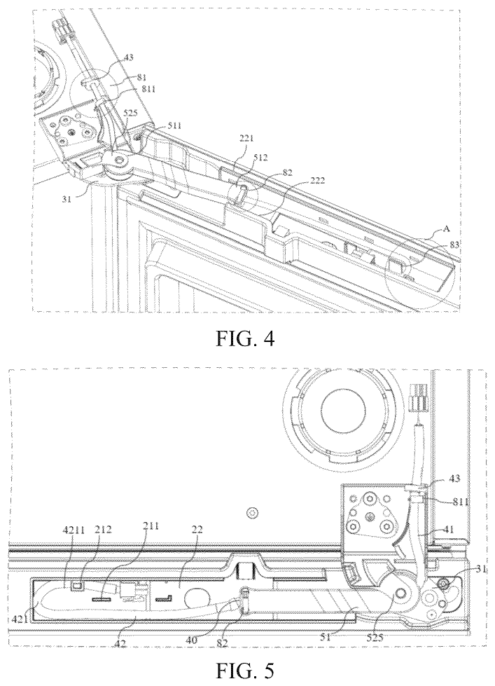

The guide member 51 may be displaced relative to the door 2 along the width direction of the door 2 during movement of the door 2. As shown in FIG. 4 and FIG. 5, when the door 2 is in a closed position, the second end 512 of the guide member 51 enters deeply into the continuous guide channel 22. In addition, because the rotation axes of the guide member 51 and the door 2 are different, when the guide member 51 rotates around the first end 511, the guide member 51 in the continuous guide channel 22 also has a circumferential displacement relative to the continuous guide channel 22.

The second end 512 of the guide member 51 may be limited by a front channel wall 221 and a rear channel wall 222 that are opposite to each other and that are of the continuous guide channel 22.

The main body 1 is provided with an accommodating part 11, and one end of the line 4 is connected, in the accommodating part 11, to another line (not shown) extending from the main body 1. The accommodating part 11 may be located at the top of the main body 1.

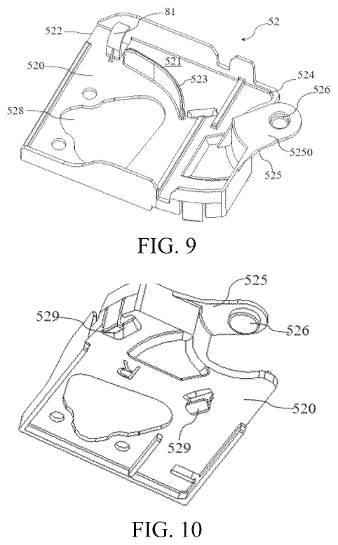

The guide mechanism 5 may include a front guide member 52 configured to guide at least one end of the line 4 between the accommodating part 11 and the guide member 51. Refer to FIG. 9 and FIG. 10 with reference to FIG. 1 to FIG. 6. The front guide member 52 may be fixed on the main body 1 and is provided with a channel 521 for restricting the line 4. In this way, the line 4 can be better guided between the main body 1 and the door 2. The line 4 is located between the hinge cover 6 and the front guide member 52.

The hinge cover 6 is provided with an extension structure 62 at the front part of the hinge cover 6 facing the door 2, and the extension structure 62 covers the first end 511 of the guide member 51 from above.

The front guide member 52 is arranged above the main body 1 and covers a part of the hinge plate 31. The front guide member 52 may be fixed to the hinge plate 31 through snap-fitting and/or screws. For example, the front guide member 52 has a plurality of buckle structures 529, and the front guide member 52 is buckled to the hinge plate 31 by using the buckle structures 529.

The front guide member 52 may be provided with an avoidance hole 528 to avoid a component protruding upward from the hinge plate 31, for example, a screw for fixing the hinge 3 to the main body 1.

The front guide member 52 is provided with an inlet end 522, a line guide structure 523, and an outlet end 524. The inlet end 522 is provided with a stop part 811 configured to limit a movement path of the line 4 and to limit movement of the line 4 within a specific length range.

A stop protrusion 43 on the line 4 works in conjunction with the stop part 811 to limit a length of the line 4 entering the guide mechanism 5.

The connection plate 525 may be integrally formed at the front end of the front guide member 52. The front guide member 52 includes a base plate 520 supported above the hinge plate 31. The connection plate 525 includes a tab 5250 that protrudes upward from the front side of the base plate 520 and then horizontally extends forward to be higher than the channel 521. In this way, a space for accommodating the first end of the guide member 51 may be formed.

The guide member 51 is rotatably connected to the second shaft part 526 extending downward from the tab 5250. There is a connection structure between the hinge cover 6 and the front part of the front guide member 52, so that the lower surface of the extension structure 62 is in surface contact with the upper surface of the tab 5250. With the support of the hinge cover 6 having higher strength, even if the upper side of the guide member 51 operates together with the tab 5250 having lower strength, high stability can still be provided for the guide member 51 at the first end 511.

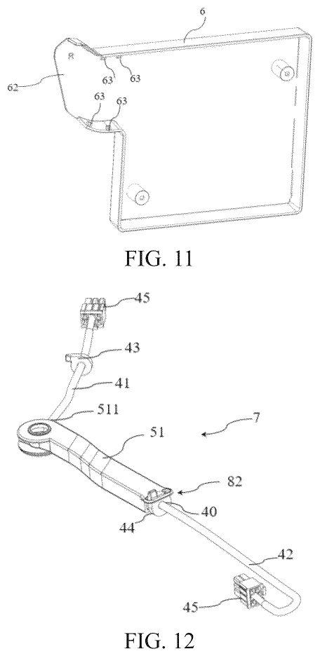

As shown in FIG. 11, the hinge cover 6 may include a plurality of snap-fit parts 63, and the snap-fit parts 63 are snap-fitted with the front guide member 52, so that the hinge cover 6 and the front part of the front guide member 52 can be held more tightly.

The snap-fit parts 63 are snap-fitted with two sides of the front guide member 52 behind the tab 5250, so that the tab 5250 can be stably attached to the lower surface of the hinge cover 6 having higher strength.

As described above, the rotation axis of the guide member 51 and the rotation axis of the door 2 do not overlap. Therefore, when the door 2 is opened or closed, the line 4 extending between the main body 1 and the door 2 is pulled or pushed to move relative to the door 2.

As shown in FIG. 4 and FIG. 5, compared with a state in which the door 2 is opened, when the door 2 is closed, more line 4 is pulled to the door 2. In addition to restricting a direction of the line 4, a certain amount of movement of the line 4 needs to be allowed, so that the line 4 is not excessively tight during movement of the door 1.

According to this embodiment of this application, the household appliance 100 has a line restriction mechanism 8, and the line restriction mechanism 8 is configured to restrict movement of the line 4 along the length direction of the line 4 so as to limit a maximum compensation length of the line 4 relative to the guide mechanism 5. By limiting the maximum compensation length of the line 4 relative to the guide mechanism 5, the line restriction mechanism 8 limits a maximum length that the line can enter the guide member 51, to prevent excessively long line 4 from being squeezed in the guide member 51 and damage to the line 4 as the guide member 51 rotates.

The line restriction mechanism 8 includes a first restriction mechanism 81 adapted to limit a movement range of the line 4 located on the main body 1 toward the door 2 and/or a second restriction mechanism 82 adapted to limit a movement range of the line 4 located on the door 2 toward the main body 2.

In some embodiments, the first restriction mechanism may be located at the main body, and the second restriction mechanism is located at the door.

In some embodiments, the first restriction mechanism may be located at one end of the guide mechanism, and the second restriction mechanism is located at the other end of the guide mechanism.

The household appliance 100 supplies electricity or a liquid from the main body 1 to the door 2 through the line 4. Therefore, for ease of description, in descriptions of embodiments, a line section located at the main body 1 is located upstream relative to a line section located at the door 2, the first end 511 is located upstream relative to the second end 512, and the front guide member 52 is located upstream relative to the guide member 51.

The first restriction mechanism 81 is configured to restrict a line section located upstream of the first end 511 of the guide member 51. The first restriction mechanism 81 limits a length of the line 4 entering the guide member 51 via the first end 511.

The first restriction mechanism 81 may be located upstream of the first end 511 of the guide member 51.

The second restriction mechanism 82 may be located downstream of the first end 511 of the guide member 51, to limit a length of the line 4 entering the guide member 51 via the second end 512 of the guide member 51.

In an embodiment, the first restriction mechanism 81 is configured to: after a corresponding line section moves a specific distance along the length direction thereof, prevent the line 4 from continuing to move along the direction, to prevent the line 4 from entering the guide member 51 excessively.

In an embodiment, the second restriction mechanism 82 fixes the line 4 to a component adjacent to the line 4 in such a manner: when the door 2 moves, even though the line 4 moves with movement of the door 2, a fixed part 40 of the line 4 remains unchanged relative to the adjacent component. In this way, relative to the fixed part 40 of the line 4, the line 4 is divided into a first line section 41 located on one side of the fixed part 40 of the line and a second line section 42 located on the other side of the fixed part 40 of the line, and when the door 2 moves, the length of the first line section 41 and the length of the second line section 42 may remain constant.

In other words, relative to the second restriction mechanism 82, the line 4 is divided into the first line section 41 located on one side of the second restriction mechanism 82 and the second line section 42 located on the other side of the second restriction mechanism 82. Therefore, the line 4 may be divided into two segments whose lengths are not affected by movement of the door 2 and the line 4. The first line section and the second line section are less prone to displacement during movement. This can improve the controllability of a movement trajectory of the line 4.

The first restriction mechanism 81 may include the stop part 811 and the stop protrusion 43 protruding from the outer side of the line 4. The stop part 811 has a stop passage 813 that allows the line 4 to pass through and can prevent the stop protrusion 43 from passing through.

The stop part 811 may include an arc-shaped elastic hook 814, and the elastic hook 814 limits the stop passage 813. This is convenient for the line 4 to be placed into the stop passage 813. The stop protrusion 43 may be integrally formed on the outer side of the line 4, or in an alternative embodiment, the stop protrusion 43 may be formed by a wire clip or a cable tie fastened around the outside of the line 4.

The stop part 811 is closer to the first end 511 of the guide member 51 than the stop protrusion 43 is. When the line 4 is pulled toward the direction of the door 2 during movement of the door 2, the line 4 carries the stop protrusion 43 to move toward the direction of the door 2 until the stop protrusion 43 and the stop part 811 abut against each other, so that further movement of the line 4 toward the direction of the door 2 is prevented.

Because the line 4 is fixed by the second restriction mechanism 82 at a downstream position of the first end 511 of the guide member 51, a maximum compensation length for which the line 4 can move relative to the guide member 51 is limited by the length of the line between the stop protrusion 43 and the stop part 811 of the first restriction mechanism 81 when the stop protrusion 43 and the stop part 811 of the first restriction mechanism 81 are farthest.

When the line 4 is pushed toward the main body 1 during movement of the door 2, the part of the line 4 that enters the guide member 51 may exit the guide member 51. From an opened position (FIG. 4) of the door 2 to a closed position (FIG. 5) of the door 2, a part of the line 4 in the guide member 51 may be pulled into the guide member 51 via an opening of the guide member 51, but the first restriction mechanism 8 can prevent entry of excessively long line 4 into the guide member 51, thereby preventing the line 4 from being squeezed and damaged in the guide member 51 as the guide member 51 moves.

In an embodiment, the second restriction mechanism 82 fixes the line 4 to the guide member 51. In this way, both the line 4 and the guide member 51 can be moved in a bound manner. Therefore, the line 4 can be located in the guide member 51 with more restricted movement, reducing bending in the line 4 adjacent to the second restriction mechanism 82.

The second restriction mechanism 82 is at least partially located in the guide passage 510. The second restriction mechanism 82 may include a cable tie 44 for bundling and fixing the line 4 to the guide member 51. The second restriction mechanism 82 may include at least one fixing hole 519 penetrating a wall of the guide member 51, and the cable tie 44 passes through the fixing hole 519 to fix the line 4 to the guide member 51.

The second restriction mechanism 82 may be located at the second end 512 of the guide member 51. The first line section 41 located upstream of the second end 512 of the guide member 51 may be substantially moved in the first end 511 and upstream of the first end 511, and the second line section 42 may be substantially moved in the continuous guide channel 22.

The second end 512 may include an extension piece 518 extending beyond the guide passage 510, and fixing holes 519 are distributed on the extension piece 518. The extension piece 518 may be located above the guide passage 510, and a part of the line 4 located below the extension piece 518 is exposed. The cable tie 44 may extend below the line 4 and wrap around the line 4 upward, and then pass through the fixing hole 519 to perform binding. In this way, it is beneficial for the line 4 to be fixed to the guide member 51.

As shown in FIG. 4 and FIG. 5, the second line section 42 extends from the fixed part 40 toward a side of the continuous guide channel 22 away from the hinge 3 and bends back near a closed end of the continuous guide channel 22 to form a U-shaped part 421.

The household appliance 100 is provided with a third restriction mechanism 83 configured to limit a movement range of the second line section 42 toward the hinge side of the door 2.

In an embodiment, the door 2 is provided with a partition structure 211 located in the continuous guide channel 22 and between two leg parts of the U-shaped part 421, so that the second line section 42 can be reliably formed into a U-shape part. The partition structure 211 may include a protruding rib protruding from the bottom wall of the continuous guide channel 22.

The door 2 may further include an upper stop part 212 located outside the U-shaped part 421 and adjacent to the partition structure 211. The upper stop part 212 is located above the second line section 42 to stop the second line section 42 from exiting the continuous guide channel 22 upwards. The upper stop part 212 may be arranged in the continuous guide channel 22 in a manner of protruding from one inner wall of the continuous guide channel 22 to the other inner wall.

The upper stop part 212 may be spaced apart from the partition structure 211 along the extension direction of the second line section 42. A part of the second line section 42 extends between the partition structure 211 and the upper stop part 212. Specifically, a bent leg part 4211 of the U-shaped part 421 is located between the partition structure 211 and the upper stop part 212.

In this way, the second line section 42 may stably move with the guide member 51 when the door 2 moves.

When the door 2 is in the closed position, as shown in FIG. 5, the second line section 42 is closer to the closed end of the continuous guide channel 22. During opening of the door 2, the guide member 51 pulls the second line section 42 to move toward the open end of the continuous guide channel 22. Specifically, the line 4 is pulled toward the main body 1, and the U-shaped part 421 moves relative to the door 2 toward a direction away from the closed end of the continuous guide channel 22.

When the door 2 is opened to a maximum angle, the U-shaped part 421 may move to a position suitable for being stopped by the partition structure 211, as shown in FIG. 4.

During closing of the door 2, the guide member 51 pushes the second line section 42 to move toward the closed end of the continuous guide channel 22, until the state shown in FIG. 5 is approximately restored.

Because the two leg parts of the U-shaped part 421 are partitioned by using the partition structure 211, the second line section 42 can be distributed in an orderly manner in the continuous guide channel 22. In addition, the bent leg part 4211 is sandwiched between the dividing structure 211 and the upper stop part 212, so that the second line section 42 can maintain the U shape more orderly. Movement of the second line section 42 in the continuous guide channel 22 is mainly reflected in a position change of the U-shaped part 421 relative to the door 2, so that a movement trajectory of the second line section 42 relative to the door 2 is more controllable.

In an embodiment, before being mounted in the household appliance 100, the line 4 and the guide member 51 are assembled into a line assembly 7. As shown in FIG. 12, the line 4 passes through the guide member 51 and is fixed to the guide member 51 through the second restriction mechanism 82. Specifically, the line 4 is bound to the guide member 51 by using the cable tie 44. The line 4 is fixed to the guide member 51 in such a manner that when a tension within a predetermined range is applied to one side of the fixed part 40 of the line 4, the fixed part 40 of the line 4 may not be displaced relative to the guide member 51. In this way, movement of the line 4 on two sides of the fixed part 40 can be properly isolated, so that the lengths of line sections on two sides of the line 4 may not change with the movement of the door 2.

To precisely distribute the line 4 on the main body 1 and the door 2, the length of the line 4 relative to the rotatable guide member 52 may be allocated when assembling the line 4 and the guide member 51. For example, the length of the line 4 may be measured, so that the first line section 41 of a first predetermined length is distributed on one side of the fixed part 40 of the line 4, and the second line section 42 of a second predetermined length is distributed on the other side of the fixed part 40 of the line 4.

In this way, after the line assembly 7 is assembled on the household appliance 100, the lengths of the line 4 on the main body 1 and the door 2 can be precisely allocated.

The second restriction unit 82 is assembled to the household appliance 100 together with the line assembly 7, so that distribution of the line 4 relative to the door 2 during the movement of the door 2 can be more accurately controlled.

In addition, the stop protrusion 43 may be formed on/assembled in advance on the line assembly 7. The stop protrusion 43 may be a cable tie fastened around the outside of the line 4. Therefore, after the line assembly 7 is assembled to the household appliance 100, the line restriction mechanism 8 configured to limit a maximum compensation length by which the line 4 may enter the guide mechanism 5 may be obtained.

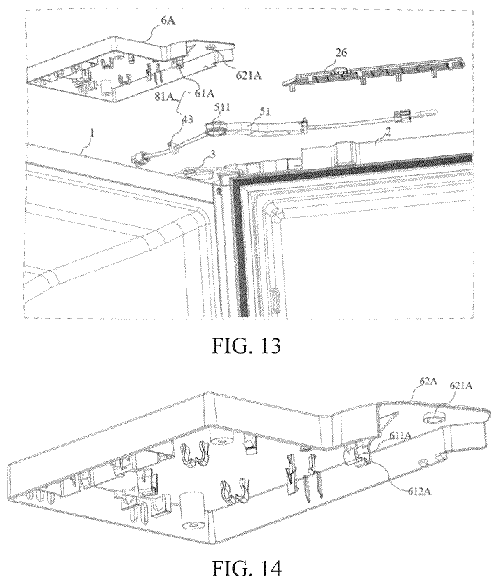

FIG. 13 is a partial schematic exploded view of a refrigeration appliance 100A according to another embodiment of this application. FIG. 14 is a perspective view of a hinge cover in FIG. 13. A main difference between this embodiment and the foregoing embodiments lies in the construction of a hinge cover and a guide mechanism. Therefore, for brevity and ease of understanding, reference numerals of elements in FIG. 13 and FIG. 14 that are the same as those in the foregoing embodiments are the same as those in FIG. 1 to FIG. 12, and different elements are marked with different reference numerals.

In FIG. 1 to FIG. 12, the additional front guide member 52 is used to limit a movement range of the line 4. However, in this embodiment, as shown in FIG. 13 and FIG. 14, the lower side of a hinge cover 6A for covering a hinge 3 is provided with a stop part 61A for limiting a line 4 on the side of a main body 1 from continuing to move toward the direction of a guide member 51. The limiting part 61A defines a stop passage 611A that allows the line 4 to pass through and prevents a stop protrusion 43 located on the outer side of the line 4 from passing through. Along the length direction of the line 4, the stop part 61A is located between the stop protrusion 43 and the guide member 51, so that the length of the line 4 entering the guide member 51 can be limited by using a first restriction mechanism 81A formed by the stop part 61A and the stop protrusion 43.

In this embodiment, the stop part 61A includes a pair of elastic hooks 612A, and the two elastic hooks 612A together define the stop passage 611A. After the line 4 is assembled to the household appliance 100, the stop part 61A is closer to a first end 511 of the guide member 51 than the stop protrusion 43 is. When the line 4 is pulled toward the direction of a door 2 during movement of the door 2, the line 4 carries the stop protrusion 43 to move toward the direction of the door 2 until the stop protrusion 43 and the stop part 61A abut against each other, so that further movement of the line 4 toward the direction of the door 2 is prevented.

Different from the foregoing embodiments in which the rotatable guide member 51 is rotatably connected to the tab 5250 of the front guide member 52, in this embodiment, the first end 511 of the rotatable guide member 51 is sandwiched between a hinge plate 31 and the hinge cover 6A, and the guide member 51 is rotatably connected to the hinge cover 6A. Specifically, the hinge cover 6A is provided with a connection plate 62A covering the first end 511 of the guide member 51 from above, the connection plate 62A is provided with a shaft part 621A protruding downward from the lower surface of the connection plate 62A, and the shaft part 621A may be inserted into a shaft hole located at the first end 511 of the guide member 51, so that the guide member 51 can be rotatably connected to the hinge cover 6A.

The lower side of the guide member 51 may still be pivotally connected to the hinge plate 31 as shown in the foregoing embodiments.

A line guide structure configured to guide the line 4 may be further formed at the lower side of the hinge cover 6A.

In this way, the stop part 61A for limiting the movement range of the line 4 toward the door 2 and the connection plate 62A and the shaft part 621A for connecting the rotatable guide member 51 are arranged on the hinge cover 6A, so that the front guide member 52 does not need to be additionally provided.

In the foregoing embodiments, one of the first restriction mechanism 81 and a second restriction mechanism 82 is configured to only unidirectionally restrict movement of the line 4, and the other of the first restriction mechanism 81 and the second restriction mechanism 82 is configured to bidirectionally restrict movement of the line 4 (where the line 4 is fixed by the second restriction mechanism). It may be understood that under the principle of this application, to limit a maximum compensation length by which the line 4 enters the guide mechanism 5, especially the guide member 51, both two restriction mechanisms may unidirectionally restrict movement of the line 4. For example, a restriction mechanism located at a main body side is configured to prevent the line from continuing to move toward the door, and a restriction mechanism located at a door side is configured to prevent the line from continuing to move toward the main body. In this way, the length of a line section that can move relative to the guide mechanism, especially, move relative to the guide member, can be limited.

Various embodiments of single parts described with reference to FIG. 1 to FIG. 14 may be combined with each other in any given manner, to achieve advantages of this application. In addition, this application is not limited to the shown embodiments. Generally, other means than the shown means may alternatively be used, provided that the means can achieve the same effect.

1. A refrigeration appliance, comprising:
a main body having a compartment;
a door disposed in front of said main body;
a hinge connecting said main body and said door, so that said door can rotate relative to said main body, wherein said hinge has a hinge plate, one end of said hinge plate is fixed to said main body, and another other end of said hinge plate is disposed at an upper part of said door;
a line, wherein a part of said line is disposed on said main body, and a further part of said line is disposed on said door;
a connection plate; and
a guide member configured to guide said line, wherein said guide member is adapted to rotate non-coaxially with said door as said door is being opened or closed, said guide member containing a first end that is pivotally connected and a second end opposite to said first end, wherein in a vertical direction, said first end is disposed between said hinge plate and said connection plate disposed above said hinge plate, and is pivotally connected to said hinge plate and said connection plate.

2. The refrigeration appliance according to claim 1, further comprising a hinge cover configured to cover said hinge plate from above, wherein said connection plate is a part of said hinge cover.

3. The refrigeration appliance according to claim 2, wherein said connection plate is disposed at a front end of said hinge cover and is disposed above said door when said door is closed.

4. The refrigeration appliance according to claim 1, further comprising a front guide member, said front guide member is fixed to said main body, said line extends toward said guide member along said front guide member, and said front guide member contains said connection plate.

5. The refrigeration appliance according to claim 4, wherein:
said front guide member has a base plate extending horizontally;
said line is lapped on said base plate; and
said connection plate has a tab extending upward from said base plate and bent before extending forward horizontally, to form, between said base plate and said tab, a space for accommodating said first end of said guide member.

6. The refrigeration appliance according to claim 5, wherein:
said base plate is disposed above said main body and covers said hinge plate; and/or
said front guide member is snap-connected to said hinge plate.

7. The refrigeration appliance according to claim 5, further comprising a hinge cover configured to cover said hinge plate from above, wherein an upper surface of said tab is in contact with a lower surface of said hinge cover, and/or said hinge cover is snap-connected to said front guide member.

8. The refrigeration appliance according to claim 1, wherein:
said hinge plate has a first shaft hole formed therein;
an upper part of said first end of said guide member having a second shaft hole formed therein;
said guide member having a first shaft part for insertion into said first shaft hole and provided at a lower part of said first end;
said connection plate having a second shaft part for insertion into said second shaft hole; and
said first shaft hole and said second shaft hole are coaxial.

9. The refrigeration appliance according to claim 1, wherein:
said guide member has a first raised part protruding toward said connection plate and disposed at an upper side of said first end, said first raised part is in contact with said connection plate; and/or
said guide member having a second raised part protruding toward said hinge plate and disposed at a lower side of said first end, and said second raised part is in contact with said hinge plate.

10. The refrigeration appliance according to claim 1, wherein said door has a continuous guide channel extending along a width direction of said door, said second end of said guide member is disposed in said continuous guide channel and is movable relative to said continuous guide channel.

11. The refrigeration appliance according to claim 1, wherein:
an upper end of said door having a recess formed therein to accommodate said hinge plate and said guide member;
an upper surface of said hinge plate is higher than a bottom wall defining said recess;
said first end and said second end of said guide member are at different heights and are not on a same horizontal plane; and
said guide member has an arc part disposed between said first end and said second end to provide transition for a height difference between said first end and said second end.

12. The refrigeration appliance according to claim 1, wherein said line is fixed to said guide member and has a fixed part, a first line section on one side of said fixed part of said line and a second line section on another side of said fixed part of said line, and during movement of said door, a length of said first line section and a length of said second line section both remain constant.

13. The refrigeration appliance according to claim 1,
wherein said the line is fixed at or near said second end; and/or
wherein said second end is disposed above said door; and/or
further comprising a cable tie for fixing said line to said guide member, and said line is fixed onto said guide member by said cable tie; and/or
wherein said guide member having a guide passage; and/or
further comprising a component for fixing said line to said guide member, said component is at least partially disposed in said guide passage of said guide member.

14. The refrigeration appliance according to claim 12, further comprising line restriction mechanisms, wherein said line restriction mechanisms are configured to restrict a movement of said line in a length direction of said line to limit the length of said line entering said guide member.

15. The refrigeration appliance according to claim 14, wherein:
at least one of said line restriction mechanisms is disposed outside said guide member; and/or
at least one of said line restriction mechanisms is disposed on said main body; and/or
at least one of said restriction mechanisms has a stop part and a stop protrusion protruding from an outer side of said first line section, and said stop part defines a stop passage that allows said first line section to pass through and prevents said stop protrusion from passing through.
